(19) United States
(12) Patent Application Publication
(10) Pub. No.: US 2013/0219061 A1
(43) Pub. Date: Aug. 22, 2013

(54) CLOUD COMPUTING DEVICE AND DISTRIBUTED DATA MANAGEMENT METHOD

(71) Applicants: SHIH-FANG WONG, Tu-Cheng (TW); XIN LU, Shenzhen City (CN); YAO-HUA LIU, Shenzhen City (CN)

(72) Inventors: SHIH-FANG WONG, Tu-Cheng (TW); XIN LU, Shenzhen City (CN); YAO-HUA LIU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/452,545

(22) Filed: Apr. 20, 2012

(30) Foreign Application Priority Data
Feb. 20, 2012 (CN) 201210037804.X

(51) Int. Cl. G06F 15/173

(52) U.S. Cl. 709/225

(57) ABSTRACT

A distributed data management method implemented by a cloud computing device, the cloud computing device is in communication with a plurality of client devices through a network. Basic information of various data of the client devices are received and stored by the cloud computing device through the network. Whether a first client device is authorized to access a target data is verified, when the first client device requests access to the target data through the cloud computing device. The target data is acquired from a second client device according to the basic information of the target data, and the acquired data is transmitted to the first client device through the network, upon the condition that the first client device is authorized to access the target data.

### BACKGROUND

1. Technical Field

Embodiments of the present disclosure relate generally to cloud storage technologies, and particularly to a cloud computing device and a distributed data management method.

2. Description of Related Art

Cloud storage services are widely used by individuals and companies for storing important data. The cloud storage services are provided by third parties, and users can directly store their data to data centers provided by the third parties through particular networks, such as the Internet. One or more cloud storage devices may act as a data center. A large amount of data from various client devices may be transmitted to and stored in the data center, and the data center may provide a data sharing service to the client devices through the networks. Since a large amount of data will be stored in the data center, the cloud storage devices with high performance and a large storage space are desired, which is costly for the third parties.

### BRIEF DESCRIPTION OF THE DRAWINGS

FIG. 1 is a schematic block diagram illustrating one embodiment of a cloud computing device in communication with a plurality of client devices through a network.

FIG. 2 is a schematic diagram of an exemplary embodiment of functional modules of the cloud computing device of FIG. 1.

FIG. 3 is a flowchart of one embodiment of a distributed data management method implemented by the cloud computing device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

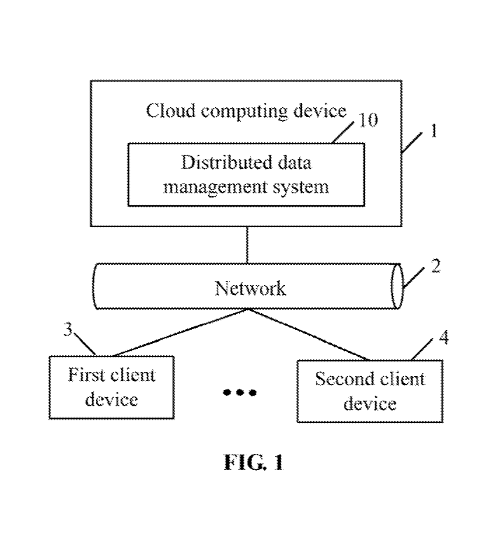

FIG. 1 is a schematic diagram illustrating one embodiment of a cloud computing device 1 in communication with a plurality of client devices through a network 2. In the embodiments, the client devices include at least a first client device 3 and a second client device 4. In the embodiment, a distributed data management system 10 is installed in and implemented by the cloud computing device 1 to manage data dispersedly stored in the client devices. The network 2 may be a wired network or a wireless network. The cloud computing device 1 may be a cloud server, a computer, or other similar computing device. Each of the client devices including the first client device 3 and the second client device 4 may be, for example, a personal computer, a tablet computer, or a smart phone.

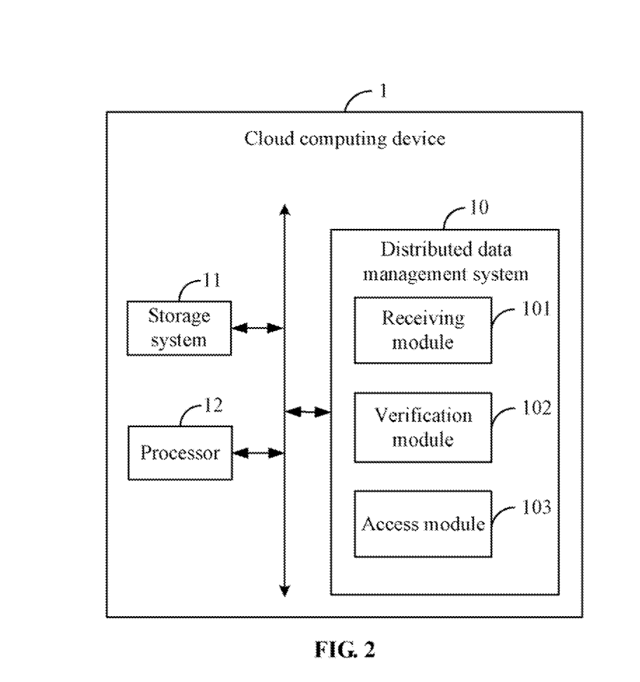

FIG. 2 is a schematic diagram of functional modules of the cloud computing device 1 in accordance with an exemplary embodiment. In the embodiment, the cloud computing device 1 includes a storage system 11, at least one processor 12 and the distributed data management system 10. The distributed data management system 10 includes a receiving module 101, a verification module 102, and an access module 103. The modules 101-103 may include computerized codes in the form of one or more programs that are stored in the storage system 11. The computerized codes include computer-readable program codes (instructions) that are executed by the at least one processor 12 to provide functions for the modules 101-103. The storage system 11 may be a cache or a memory, such as an erasable programmable read only memory (EPROM), a hard disk drive (HDD), or a flash memory. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The receiving module 101 receives basic information of various data stored in the client devices through the network 2, and stores the received basic information into the storage system 11. In the embodiment, the basic information of the data includes a data name and a data size of the data, an address (e.g., IP address and Mac address) of the client device where the data is stored, a storage location of the data in the client device, and verification information (e.g., password) for accessing the data. In one embodiment, the basic information of the data may be transmitted to the cloud computing device 1 according to user requirements. In another embodiment, the receiving module 101 may automatically acquire the basic information of the data from the corresponding client device according to the data name of the data provided by the user using any client device in advance.

The receiving module 101 further creates a user interface, and displays the received basic information to any user through the user interface when the user login onto the cloud computing device 1 using the client device.

The verification module 102 verifies if one of the client devices, which requests access to a target data through the cloud computing device 1, is authorized to access the target data. In the embodiment, it is assuming that the first client device 3 requests access to the target data, and the target data is stored in the second client device 4. The basic information of the target data has been stored in the storage system 11 of the cloud computing device 1. The first client device 3 may request to access the target data by selecting/clicking any item of the basic information (e.g., the data name) of the target data through the user interface. The verification module 102 may notify the user of the first client device 3 to input verification information and determine the first client device 3 is authorized when valid verification information is inputted. If the user has not input the valid verification information within a predetermined time period, such as three seconds or five seconds, the verification module 102 determines the first client device 3 is not authorized to access the target data. In other embodiments, the basic information of the target data may not include the verification information, and the verification module 102 may directly determine that the first client device 3 has the authorization to access the target data. The verification information of the target data may be set by the user of the second client device 4.

The access module 103 acquires the target data from the second client device 4 according to the basic information of the target data, and transmits the acquired target data to the first client device 3 through the network 2, if the first client device 3 is authorized to access the target data. In one example, the access module 103 may access the second client device 4 according to the IP address or Mac address of the client device 4 through the network 2, and then acquires the target data according to the location of target data in the second client device 4. Thus, since the basic information of the various data is stored in the cloud computing device 1, the various data is dispersedly stored in different client devices accordingly, and the client devices can share their data with each other, a large amount of storage space of the cloud computing device 1 can be saved.

Additionally, the target data may be backed up in the first client device 3 after the target is transmitted to the first client device 3. The access module 103 further records an access log of the target data in the storage system 11. If the target data of the second client device 4 is destroyed or lost, the access module 103 may recover the target data from the first client device 3 to the second client device 4. In one embodiment, the access log includes an address of the second client device 4 where the target data is sourced from, and an address of the first client device 3 accessed the target data.

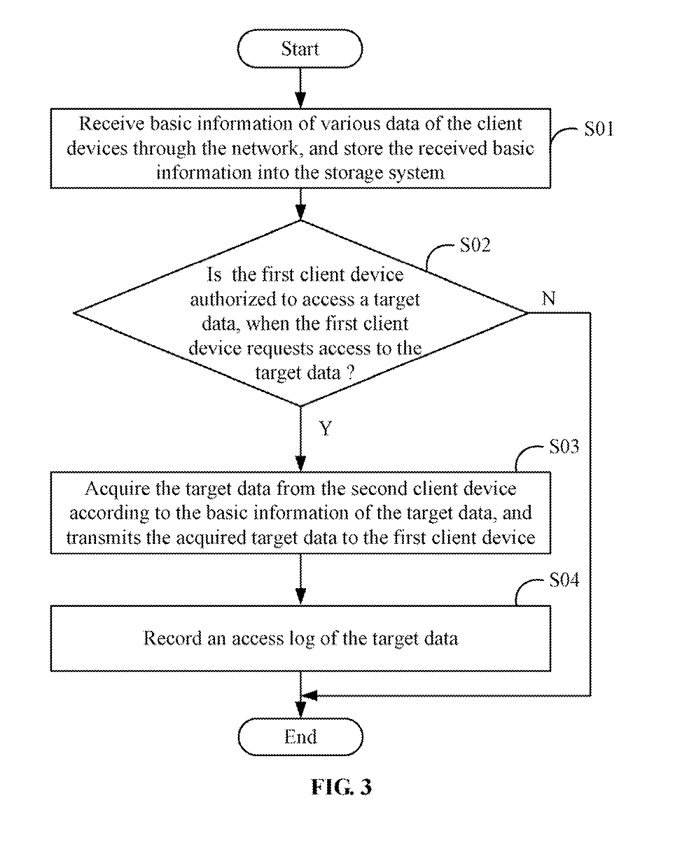

FIG. 3 is a distributed data management method implemented by the cloud computing device 1. Depending on the embodiment, additional steps may be added, others removed, and the ordering of the steps may be changed.

In step S01, the receiving module 101 receives basic information of various data of the client devices through the network 2, and stores the received basic information into the storage system 11. Additionally, in this step, the receiving module 101 further creates a user interface, and displays the received basic information of various data on the user interface, so that the user of the client device can access any data by selecting corresponding information of the data through the user interface when the client device logins onto the cloud computing device 1.

In step S02, the verification module 102 verifies if a client device is authorized to access a target data upon the condition that the client device requests access to the target data. In the embodiment, it is assumed that the first client device 3 requests access to the target data, which is stored in the second client device 4.

In step S03, the access module 103 acquires the target data from the second client device 4 according to the basic information of the target data, and transmits the acquired target data to the first client device 3 through the network 2, if the first client device 3 is authorized to access the target data.

In step S04, the access module 103 records an access log of the target data in the storage system 11. Thus, if the target data of the second client device 4 is destroyed or lost, the second client device 4 can recover the target data from the first client device 3 according the recorded access log.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A distributed data management method implemented by a cloud computing device, the cloud computing device communicating with a plurality of client devices through a network, the method comprising:
receiving basic information of various data of the client devices through the network, and storing the received basic information into a storage system of the cloud computing device;
verifying whether a first client device is authorized to access a target data, upon the condition that the first client device requests access to the target data through the cloud computing device; and
acquiring the target data from a second client device in which the target data is stored according to the basic information of the target data, and transmits the acquired target data to the first client device through the network, when the first client device is determined to be authorized to access the target data.

2. The method according to claim 1, wherein the basic information of the data comprise a data name and a data size of the data, an address of the client device where the data is stored, a storage location of the data in the client device, and verification information for accessing the data.

3. The method according to claim 2, wherein the verifying step comprises:
notifying a user of the first client device to input the verification information to access the target data; and
determining the first client device is authorized to access the target data when valid verification information is inputted, or determining the first client device is not authorized to access the target data when the user has not input the valid verification information within a predetermined time period.

4. The method according to claim 1, wherein the receiving step comprises:
creating a user interface, and displaying the received basic information to the user of any client device through the user interface when the client device login onto the cloud computing device.

5. The method according to claim 1, further comprising:
recording an access log of the target data in the storage system, the access log comprising an address of the first client device, and an address of the second client device; and
recovering the target data from the first client device to the second client device according to the recorded access log.

6. A cloud computing device in communication with a plurality of client devices through a network, the cloud computing device comprising:
a storage system;
at least one processor;
one or more programs stored in the storage system and executed by the at least one processor, the one or more programs comprising:
a receiving module that receives basic information of various data of the client devices through the network, and stores the received basic information into the storage system;
a verification module that verifies whether a first client device, which requests access to a target data through the cloud computing device, is authorized to access the target data; and
an access module that acquires the target data from a second client device in which the target data is stored according to the basic information of the target data, and transmits the acquired target data to the first client device through the network, when the first client device is determined to be authorized to access the target data.

7. The cloud computing device according to claim 6, wherein the basic information of the data comprise a data name and a data size of the data, an address of the client device where the data is stored, a storage location of the data in the client device, and verification information for accessing the data.

8. The cloud computing device according to claim 7, wherein the first client device is verified by:
notifying a user of the first client device to input the verification information to access the target data; and
determining the first client device is authorized to access the target data when a valid verification information is inputted, or determining the first client device is not authorized to access the target data when the user has not input the valid verification information within a predetermined time period.

9. The cloud computing device according to claim 6, wherein the receiving module that further creates a user interface, and displays the received basic information to the user of any client device through the user interface when the client device login onto the cloud computing device.

10. The cloud computing device according to claim 6, wherein the access module further records an access log of the target data in the storage system, the access log comprising an address of the first client device, and an address of the second client device.

11. The cloud computing device according to claim 10, wherein the access module further recovers the target data from the first client device to the second client device.
